(19) United States
(12) Patent Application Publication
(10) Pub. No.: US 2010/0142316 A1
(43) Pub. Date: Jun. 10, 2010

(54) USING WAVEFORM INVERSION TO DETERMINE PROPERTIES OF A SUBSURFACE MEDIUM

(76) Inventors: Henk Keers, Oslo (NL); Paul Childs, Cambridge (GB)

Correspondence Address: WesternGeco L.L.C.;Kevin McEnaney, 10001 Richmond Avenue, HOUSTON, TX, 77042-4299, US

(21) Appl. No.: 12/329,593

(22) Filed: Dec. 7, 2008

(51) Int. Cl. G01V 1/38; G01V 1/28

(52) U.S. Cl. 367/15; 367/73

(57) ABSTRACT

A technique includes providing seismic data acquired in a seismic survey of a medium. The seismic data includes particle motion data. The technique includes modeling waves propagating through the medium during the survey as a function of at least one property of the medium and the seismic data. The technique includes, based on the modeling, determining the property(ies) of the medium.

### BACKGROUND

The invention generally relates to using waveform inversion to determine properties of a subsurface medium.

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones and/or accelerometers), and industrial surveys may deploy only one type of sensors or both. In response to the detected seismic events, the sensors generate electrical signals to produce seismic data. Analysis of the seismic data can then indicate the presence or absence of probable locations of hydrocarbon deposits.

Some surveys are known as “marine” surveys because they are conducted in marine environments. However, “marine” surveys may be conducted not only in saltwater environments, but also in fresh and brackish waters. In one type of marine survey, called a “towed-array” survey, an array of seismic sensor-containing streamers and sources is towed behind a survey vessel.

### SUMMARY

In an embodiment of the invention, a technique includes providing seismic data acquired in a seismic survey of a medium. The seismic data includes particle motion data. The technique includes modeling waves propagating through the medium during the survey as a function of at least one property of the medium and the seismic data. The technique includes, based on the modeling, determining the property(ies) of the medium.

In another embodiment of the invention, a system includes an interface and a processor. The interface receives seismic data acquired in a seismic survey of a medium. The processor processes the seismic data to model waves propagating through the medium during the survey as a function of at least one property of the medium and the seismic data.

In yet another embodiment of the invention, an article that includes a computer readable storage medium that store instructions that when executed by a processor-based system cause the processor-based system to receive seismic data acquired in a seismic survey of a medium. The seismic data includes particle motion data. The instructions when executed cause the processor-based system to process the seismic data to model waves propagating through the medium during the survey as a function of at least one property of the medium and the seismic data.

Advantages and other features of the invention will become apparent from the following drawing, description and claims.

### BRIEF DESCRIPTION OF THE DRAWING

FIG. 1 is a schematic diagram of a marine-based seismic data acquisition system according to an embodiment of the invention.

FIG. 2 is a flow diagram depicting a technique to determine at least one property of a subsurface medium using waveform inversion according to an embodiment of the invention.

FIG. 3 is a schematic diagram of a seismic data processing system according to an embodiment of the invention.

### DETAILED DESCRIPTION

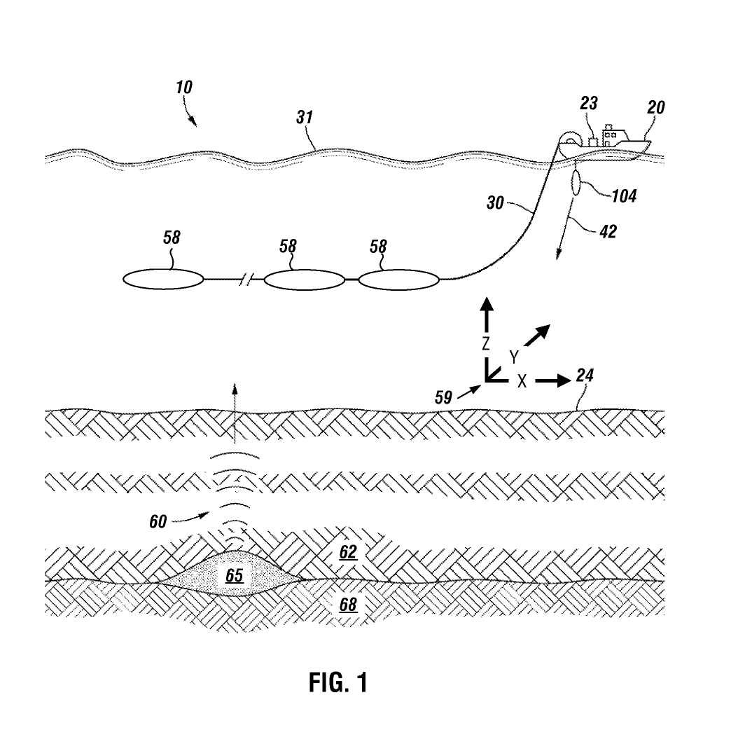

FIG. 1 depicts an embodiment 10 of a marine seismic data acquisition system in accordance with some embodiments of the invention. In the system 10, a survey vessel 20 tows one or more seismic streamers 30 (one exemplary streamer 30 being depicted in FIG. 1) behind the vessel 20. The seismic streamers 30 may be several thousand meters long and may contain various support cables (not shown), as well as wiring and/or circuitry (not shown) that may be used to support communication along the streamers 30. In general, each streamer 30 includes a primary cable into which is mounted seismic sensors 58 that record seismic signals.

In accordance with embodiments of the invention, the seismic sensors 58 may be pressure sensors only or may be multi-component seismic sensors. For the case of multi-component seismic sensors, each sensor is capable of detecting a pressure wavefield and at least one component of a particle motion that is associated with acoustic signals that are proximate to the multi-component seismic sensor. Examples of particle motions include one or more components of a particle displacement, one or more components (inline (x), crossline (y) and vertical (z) components (see axes 59, for example)) of a particle velocity and one or more components of a particle acceleration.

Depending on the particular embodiment of the invention, the multi-component seismic sensor may include one or more hydrophones, geophones, particle displacement sensors, particle velocity sensors, accelerometers, pressure gradient sensors, or combinations thereof.

For example, in accordance with some embodiments of the invention, a particular multi-component seismic sensor may include a hydrophone for measuring pressure and three orthogonally-aligned accelerometers to measure three corresponding orthogonal components of particle velocity and/or acceleration near the seismic sensor. It is noted that the multi-component seismic sensor may be implemented as a single device or may be implemented as a plurality of devices, depending on the particular embodiment of the invention. A particular multi-component seismic sensor may also include pressure gradient sensors, which constitute another type of particle motion sensors. Each pressure gradient sensor measures the change in the pressure wavefield at a particular point with respect to a particular direction. For example, one of the pressure gradient sensors may acquire seismic data indicative of, at a particular point, the partial derivative of the pressure wavefield with respect to the crossline direction, and another one of the pressure gradient sensors may acquire, a particular point, seismic data indicative of the pressure data with respect to the inline direction.

The marine seismic data acquisition system 10 includes a seismic source 104 that may be formed from one or more seismic source elements, such as air guns, for example, which are connected to the survey vessel 20. Alternatively, in other embodiments of the invention, the seismic source 104 may operate independently of the survey vessel 20, in that the seismic source 104 may be coupled to other vessels or buoys, as just a few examples.

As the seismic streamers 30 are towed behind the survey vessel 20, acoustic signals 42 (an exemplary acoustic signal 42 being depicted in FIG. 1), often referred to as “shots,” are produced by the seismic source 104 and are directed down through a water column 44 into strata 62 and 68 beneath a water bottom surface 24. The acoustic signals 42 are reflected from the various subterranean geological formations, such as an exemplary formation 65 that is depicted in FIG. 1.

The incident acoustic signals 42 that are acquired by the sources 40 produce corresponding reflected acoustic signals, or pressure waves 60, which are sensed by the seismic sensors 58. It is noted that the pressure waves that are received and sensed by the seismic sensors 58 include “up going” pressure waves that propagate to the sensors 58 without reflection, as well as “down going” pressure waves that are produced by reflections of the pressure waves 60 from an air-water boundary 31.

The seismic sensors 58 generate signals (digital signals, for example), called “traces,” which indicate the acquired measurements of the pressure wavefield and particle motion (if the sensors are particle motion sensors). The traces are recorded and may be at least partially processed by a signal processing unit 23 that is deployed on the survey vessel 20, in accordance with some embodiments of the invention. For example, a particular multi-component seismic sensor may provide a trace, which corresponds to a measure of a pressure wavefield by its hydrophone; and the sensor may provide one or more traces that correspond to one or more components of particle motion, which are measured by its accelerometers.

The goal of the seismic acquisition is to build up an image of a survey area for purposes of identifying subterranean geological formations, such as the exemplary geological formation 65. Subsequent analysis of the representation may reveal probable locations of hydrocarbon deposits in subterranean geological formations. Depending on the particular embodiment of the invention, portions of the analysis of the representation may be performed on the seismic survey vessel 20, such as by the signal processing unit 23.

Seismic data typically is processed in a large number of steps, which may be characterized into four categories: 1.) noise attenuation; 2.) multiple removal; 3.) migration velocity analysis; and 4.) imaging. As described herein, waveform inversion is used for purposes of determining properties (propagation velocity, for example) of the subsurface from the seismic data. Moreover, as described herein, pressure data as well as particle motion data are used to derive an improved picture of the subsurface, address uncertainty estimates and reduce artifacts due to noise.

Waveform inversion refers to the derivation of one or more properties of the subsurface from the seismic data based on waveform modeling. Waveform modeling aims at describing the character of waves, which propagate through a medium The medium may be described in various ways, such as being acoustic, viscoacoustic, elastic, anelastic, poroelastic etc. The character of the waves may be determined by solving the corresponding wave equations.

An acoustic wave may be modeled by solving the constant density acoustic wave equation, which is set forth below:

$${c}^{- 2} ( x ) \frac{{\partial }^{2} u ( x , t )}{\partial {t}^{2}} - Δ u ( x , t ) = S ( x , t ) , \qquad Eq . 1$$

where “c” represents the propagation velocity; “u” represents the acoustic wave; and “S” represents the source. Various techniques exist to solve these types of equations. Because the propagation velocity c is, in general, spatially varying, Eq. 1 may be solved using a numerical modeling technique.

As examples, numerical modeling techniques that may be used include ray theory, beam theory, one-way and finite difference techniques. The ray theory modeling technique, which is a subset of the generalization beam theory, is relatively fast. However, the ray theory modeling technique may produce less accurate results. One-way numerical modeling techniques assume that there is one main propagation direction and may be solved using ray or beam methods, but also, the one-way wave equations may be solved using discretized full waveform numerical modeling techniques such as finite differences or finite elements. This discretization techniques solve the complete wave equation and therefore provide the fullest description of the solutions. However, these techniques may be relatively slow, which presents challenges if the models are large in Eq. 1 or one of its equivalents needs to be solved for a large three-dimensional (3-D) model and a large number of sources.

In operator form, waveform modeling may be described as follows:

d=F(m), Eq. 2.

where “d” represents the seismic data, which may be particle motion and/or pressure data; “m” represents the geology of the subsurface; and “F” represents the wavefield operator. Thus, given the model m, the seismic data d may be determined by applying the wavefield operator F. However, typically, the model m is unknown. Therefore, the “inverse” problem is solved:

m=F⁻¹(d). Eq. 3

Equation 3 represents an inversion problem, in which the entire waveform or waveforms are used to solve the problem. From a numerical processing standpoint, solving Eq. 3 may be very challenging because the operator F⁻¹ is highly nonlinear. To simplify the process, the problem that is set forth by Eq. 3 may be first simplified by linearizing the equation as follows. The change in the data d due to a small change in the model m may be described as follows:

$$\partial ( m + δ m ) \approx \partial ( m ) + \frac{\partial d}{\partial m} δ m . \qquad Eq . 4$$

The partial derivative

$$“ \frac{\partial d}{\partial m} ”$$

may be computed using any of the numerical processing techniques that are set forth above. With a starting model for m, d(m) may be determined using the same numerical processing techniques and subtracted from the observed data d(m+δm) to derive the following relationship:

$$δ d = \frac{\partial d}{\partial m} δ m . \qquad Eq . 5$$

In practice, the seismic data are discretized (by the source and receiver index and by the frequency or time step) and so is the model m (by an index in the x, y and z directions if there is a regular grid or some other index if the model is parameterized by an irregular grid). Solving Eq. 5 therefore may involve solving a relatively large matrix equation.

The matrix equation may be regularized and solved in the least squares sense because it is ill posed. The waveform inversion may make use of repeated quasi-Newton minimizations of an objective function, which represents the data misfit; and Eq. 5 represents the character of linear systems solved at each iteration when a Gauss-Newton approximation is employed. Smoothing and damping terms may be added to this least squares inversion problem in order to regularize the equation. In this context, “smoothing” means that the solution is smooth; and “damping” means that the solution does not deviate too much from the starting model. In addition to solving for the model parameters, the source and receiver positions may also be solved. These positions are known up to a certain precision only, and any error in the source and receiver position are mapped into the velocity inversion if an accounting is not made of the position errors. In this case, Eq. 5 may be rewritten as follows:

$$δ d = \frac{\partial d}{\partial \tilde{m}} δ \tilde{m} , \qquad Eq . 6$$

where “\tilde{m}” and “δ\tilde{m}” may be represented as follows:

\tilde{m}=(m, r, s), and Eq. 7

δ\tilde{m}=(δm, δr, δs), Eq. 8

It is noted that both pressure data and particle motion data may be used, as the pressure and particle motion data may be inverted simultaneously.

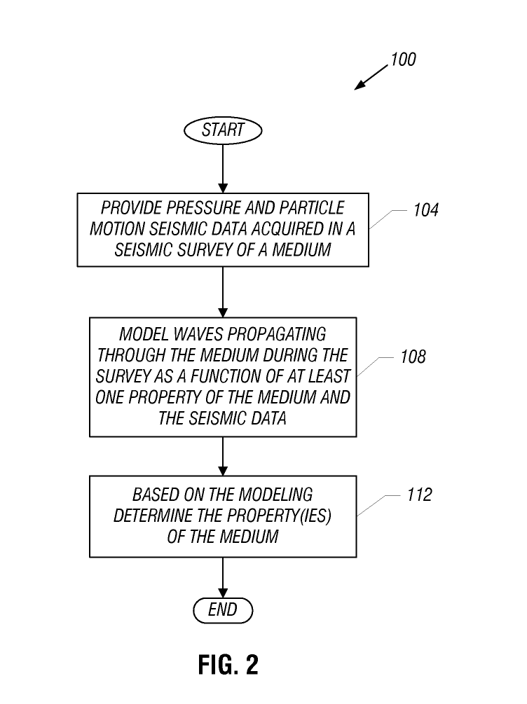

Thus, referring to FIG. 2, in accordance with some embodiments of the invention, a technique 100 includes providing seismic data acquired in a seismic survey of a medium. The seismic data includes pressure and particle motion data. The technique 100 includes modeling (block 108) waves propagated through the medium during the survey as a function of at least one property of the medium and the seismic data. The technique 100 also includes based on the modeling, determining (block 112) the property(ies) of the medium.

Because of the size of the inversion problem set forth in Eqs. 6-8, various strategies may be used to simplify these equations. One strategy, which consists of doing the waveform inversion in the frequency domain, is described in Pratt, R. G., Shin, C., and Hicks, G., J., 1998. Gauss-Newton and full Newton methods in frequency-space seismic waveform inversion: Geophys. J. Internat., 133, 341-362 (herein called the “Pratt reference”).

If the technique set forth in the Pratt reference is used and starts at the lower frequencies, then the size of the inversion problem is manageable. In this regard, higher and higher frequencies are added, in which case the inversion problem slowly becomes larger and larger. Three additional advantages to this approach are: 1.) the computation of the partial derivatives at the lower frequencies is relatively simple; 2.) the approach has a very clear physical meaning in that the large scale feature of the velocity structure is first resolved and then the more detailed structures as revealed by the higher frequencies; and 3.) the linearized inverse problem is less likely to get confined in a local minimum, which is a typical problem in large scale inversion problems.

An important aspect of waveform inversion is the starting model. The model is not unique but needs to be of sufficient quality. If the starting model is not sufficient, then the linearized waveform inversion may not converge, but rather may become confined in a local minimum.

Various techniques may be used to derive a sufficient starting model. One way involves using migration velocity analysis, which uses the travel times only.

Described below is one particular technique to compute the partial derivatives and may be advantageous for purposes of reducing the time to compute all of the partial derivatives. As starting point, a first-order Born approximation may be used, which approximately describes the propagation of the pressure waves through the heterogeneous medium, as described below:

u₁(r, s, ω)=∫ω²g(r,x,ω)c(x)c_{b}⁻³(x)g(x, s, ω)dx, Eq. 9

where “c_{b}” represents the background velocity model, which is assumed to be known; “c” represents the perturbation and the integration over the spatial variable (usually a halfspace); and “u₁” represents the first-order Born approximation. Additionally, “g(r, s, ω)” represents the Green function (corresponding to the background medium) of waves excited at the source s and recorded at the receiver r.

It is noted that in Eq. 9, source deconvolution has been applied. This is assumed to be the case below. However, it is noted that source deconvolution may not be performed, in that the techniques that are described herein are equally valid whether or not source deconvolution has been applied. In this case, one of the Green functions in Eq. 9 is convolved with the source wavelet.

The derivative of “u₁” with respect to the receiver position r may be taken, which produces the following equations:

∇ᵣu₁(r,s,ω)=∫ω²g(r,x,ω)c(x)c_{b}⁻³(x)g(x,s,ω)dx. Eq. 10

Equation 10 describes, to the first order, the propagation of the scattered gradient waves through the medium. A Fourier transform may be applied to Eqs. 9 and 10 to produce a time domain expression, and then the time domain expression may be solved using one of the numerical processing techniques that are described above. If the Green functions are used, ray theory or beam theory numerical processing techniques may be applied, such as the ones described in Keers, H., C. Chapman and D. Nichols, “A Fast Integration Technique for the Generation of Ray-Born Seismograms,” EAGE (2002).

From this technique, the partial derivatives may be efficiently computed in the time domain. Thereafter, the sensitivity functions may be transformed back to the frequency domain so that waveform inversion may be applied as described above.

As a more specific example, the Born integral may be expressed as follows:

$$u ( r , t ) = {\int }_{D} A ( x , r ) δ ( t - Φ ( x , r ) ) d x , \qquad Eq . 11$$

where “u” represents the wavefield (e.g. pressure or particle motion); “A” represents the amplitude; “Φ” represents the phase function; “t” represents time; “r” represents the receiver position vector (2-D or 3-D); and “x” represents the integration vector (2-D or 3-D).

To make the waveform discrete, the waveform is smoothed with a boxcar function B(t/Δt) that is defined as follows:

$$B ( t ) = \frac{1}{2} ( H ( t - 1 ) - H ( t - 1 ) ) , \qquad Eq . 12$$

where “H” represents the Heaviside function. B(t/Δt) is a boxcar function of length 2Δt. Smoothing Eq. 11 (i.e., convolving) with the boxcar function produces the following:

$$\begin{matrix}u ( x , t ) * B ( t / Δ t ) = {\int }_{{D}_{t}} A ( x ) d x , where & Eq . 13 \\ {D}_{t} = \{ x ∈ D \vert t - Δ t < Φ ( x ) < t + Δ t \} . & Eq . 14\end{matrix}$$

The values of A and Φ at a finite number of points are known (for example from raytracing). Therefore, triangulation (in 2-D) or tessellation (3-D) may be performed as the integration domain D. It is assumed below, the integration domain is 3-D. The 3-D tessellation produces n tetrahedrons, that are represented by “Tᵢ(i=1, . . . , n).” The expression for the wavefield now may be expressed as follows:

$$u ( r , t ) = {\sum }_{i = 1}^{n} {\int }_{{T}_{i} ⋂ {D}_{t}} A ( x ) d x . \qquad Eq . 15$$

Considering the integral over one tetrahedron Tᵢ, it may be assumed that A and Φ vary slowly within a single tetrahedron, so that a linear approximation may be applied to both A and Φ within the tetrahedron suffices. Tᵢ∩Dₜ is a polyvolume, and the following relationship may be shown:

$${\int }_{{T}_{i} ⋂ {D}_{t}} A ( x ) d x = Vol ( {T}_{i} ⋂ {D}_{t} ) {\sum }_{j = 1}^{m} \frac{A ( {y}_{j} )}{m} , \qquad Eq . 16$$

where “yⱼ” represents the m vertices of the polygon Tᵢ∩Dₜ. The volume Vol(Tᵢ∩Dₜ) can be expressed in terms of differences of volumes of tetrahedra. The algorithm for computing the synthetics is relatively straightforward, which includes two loops: one loop over the triangles/tetrahedra and another one over the polygons Tᵢ∩Dₜ.

Thus by making use of the contours of the phase function, the integral in Eq. 11 may be computed in an efficient way. In waveform inversion one needs to compute the matrix

$$\frac{\partial d}{\partial m}$$

of partial derivatives using forward modeling. The efficient Born modeling technique thus described is particularly useful as it is cheaper than either modeling using finite differences or modeling using a brute force implementation of Eq. 11. Therefore, in accordance with some embodiments of the invention, waveform inversion may be performed for any type of seismic data using the Born modeling method based on Eqs. 11 and 12. This Born modeling method is in the time domain. However, the waveform inversion may be done either in the time or frequency domain by applying an inverse FFT on Eq. 12.

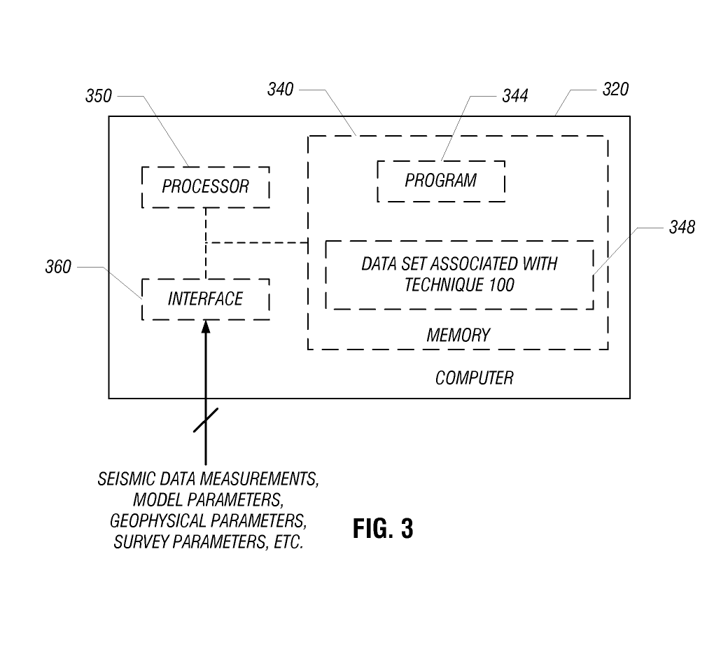

Referring to FIG. 3, in accordance with some embodiments of the invention, a data processing system 320 may perform at least part of the techniques that are disclosed herein, such as at least part of the technique 100, for such purposes as modeling waves propagating through a medium during a seismic survey and/or based on the modeling, determining at least one property of the medium. The system 320 may be located on one of the streamers 30, on each streamer 30, distributed among the streamers 30, on the seismic source 104, on the survey vessel 30, at a remote land-based facility, etc. In accordance with some embodiments of the invention, the system 320 may include a processor 350, such as one or more microprocessors and/or microcontrollers.

The processor 350 may be coupled to a communication interface 360 for purposes of receiving data indicative of seismic measurements, model parameters, geophysical parameters, survey parameters, etc. The data pertaining to the seismic measurements may be pressure data, multi-component data, etc.

As a non-limiting example, the interface 360 may be a USB serial bus interface, a network interface, a removable media (such as a flash card, CD-ROM, etc.) interface or a magnetic storage interface (IDE or SCSI interfaces, as examples). Thus, the interface 360 may take on numerous forms, depending on the particular embodiment of the invention.

In accordance with some embodiments of the invention, the interface 360 may be coupled to a memory 340 of the system 320 and may store, for example, various input and/or output data sets involved with the techniques that are described herein. The memory 340 may store program instructions 344, which when executed by the processor 350, may cause the processor 350 to perform part of the techniques that are described herein, such as at least part of the technique 100, for example, and display results obtained via the technique(s) on a display (not shown in FIG. 3) of the system 320, in accordance with some embodiments of the invention.

It is noted that the techniques that are described herein may apply to sensor cables other than streamers. For example, in accordance with other embodiments of the invention, the techniques that are described herein may apply to seabed cable. Furthermore, there are many types of marine acquisition with vector data. Not only is there the conventional narrow azimuth acquisition, but other types of acquisition may be used: coil shooting, wide-azimuth, rich-azimuth, etc. Thus, the waveform inversion techniques described herein may be applicable to all of these, as many variations are contemplated and are within the scope of the appended claims.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
providing seismic data acquired in a seismic survey of a medium, the seismic data including particle motion data;
modeling waves propagating through the medium during the survey as a function of at least one property of the medium and the seismic data; and
based on the modeling, determining said at least one property of the medium.

2. The method of claim 1, wherein the determining comprises:
determining finite changes in the seismic data due to finite changes in the model.

3. The method of claim 1, wherein the seismic data further comprises pressure data.

4. The method of claim 1, wherein the property comprises a propagation velocity.

5. The method of claim 1, wherein the act of inverting comprises inverting in the frequency domain or in the time domain.

6. The method of claim 1, wherein the act of inverting comprises using migration velocity analysis to generate initial values for the model.

7. The method of claim 1, wherein the act of inverting comprises applying a ray theory-based, beam theory-based or finite difference-based numerical inversion.

8. The method of claim 1, further comprising:
towing at least one streamer to acquire the seismic data.

9. A system comprising:
an interface to receive seismic data acquired in a seismic survey of a medium, the seismic data including particle motion data; and
a processor to process the seismic data to model waves propagating through the medium during the survey as a function of at least one property of the medium and the seismic data.

10. The system of claim 9, wherein the seismic data further comprises pressure data.

11. The system of claim 9, wherein the property comprises a propagation velocity.

12. The system of claim 9, wherein the processor is adapted to process the data to invert the model in the frequency domain or in the time domain.

13. The system of claim 9, wherein the processor is adapted to process the seismic data to invert the model based on a ray theory-based, beam theory-based or finite difference-based numerical inversion technique.

14. The system of claim 9, further comprising:
at least one streamer to acquire the seismic data.

15. The system of claim 14, further comprising:
a vessel to tow said at least one streamer.

16. The system of claim 9, further comprising:
at least one sea bed cable to acquire the seismic data.

17. An article comprising a computer readable storage medium to store instructions that when executed by a processor-based system cause the processor-based system to:
receive seismic data acquired in a seismic survey of a medium, the seismic data including particle motion data; and
process the seismic data to model waves propagating through the medium during the survey as a function of at least one property of the medium and the seismic data.

18. The article of claim 17, wherein the seismic data further comprises pressure data.

19. The article of claim 17, wherein the property comprises a propagation velocity.

20. The article of claim 17, comprising instructions that when executed cause the processor-based system to invert the model in the frequency domain or in the time domain.

21. The article of claim 17, comprising instructions that when executed cause the processor-based system to invert the model based on a ray theory-based, beam theory-based or finite difference-based numerical inversion technique.

22. A method comprising:
providing seismic data acquired in a seismic survey of a medium;
modeling a wave propagating through the medium during the survey as a function of at least one property of the medium and the seismic data, including modeling the wave as a function of a Bjorn integral having a phase function; and
based on contours of the phase function, constructing the wave.

23. The method of claim 22, wherein the seismic data comprises pressure data and/or particle motion data.

24. The method of claim 22, wherein the act of constructing is performed in the frequency domain or in the time domain.

25. The method of claim 22, further comprising:
towing at least one streamer to acquire the seismic data.
